(19) United States
(12) Patent Application Publication
(10) Pub. No.: US 2022/0124606 A1
(43) Pub. Date: Apr. 21, 2022

(54) Method for making available an access resource managed by a first operator to a second operator

(71) Applicant: ORANGE, Paris (FR)

(72) Inventors: Benoît Radier, Chatillon Cedex (FR); Nicolas Bihannic, Chatillon Cedex (FR); Gaël Fromentoux, Chatillon Cedex (FR)

(21) Appl. No.: 17/294,876

(22) PCT Filed: Nov. 12, 2019
(86) PCT No.: PCT/FR2019/052681

§ 371 Date: May 18, 2021

(30) Foreign Application Priority Data
Nov. 19, 2018 (FR) 1900048

(51) Int. Cl. H04W 48/16; H04W 28/16; H04W 16/14; H04W 72/04; H04W 48/18

(52) U.S. Cl. CPC H04W 48/16; H04W 28/16; H04W 84/045; H04W 72/0406; H04W 48/18; H04W 16/14

(57) ABSTRACT

A method for temporarily making available an access resource of a local area network of a client of a first operator to at least one second operator. The local area network is connected to a communication infrastructure of the first operator. The method is implemented by a configuration entity of the first operator and includes: transmitting an offer message, containing at least one item of service data, offering to make the at least one access resource available, to the at least one second operator; receiving a request message requesting the at least one access resource be made available, created by a management equipment of the at least one second operator from the received at least one item of data; and transmitting a configuration message for configuring at least one parameter of the at least one access resource, triggered following the received request message.

### 1. CROSS-REFERENCE TO RELATED APPLICATION

This application is a Section 371 National Stage Application of International Application No. PCT/FR2019/052681, filed Nov. 12, 2019, the content of which is incorporated herein by reference in its entirety, and published as WO 2020/104741 on May 28, 2020, not in English.

### 2. TECHNICAL FIELD

The application for invention lies in the field of access networks of communications architectures and aims for a first operator to delegate access resources of a local area network to a second operator in order for this second operator to improve its service offering to its own clients.

### 3. PRIOR ART

A Femtocell device comprises an antenna that provides radio connectivity to a client. The Femtocell device is connected to a line of a (fixed or mobile) access network of the client. Such a device is offered to clients who do not have cellular radio coverage at home. By default, this device, also called “Home eNodeB” (HeNB), is deactivated if it interferes with the infrastructure of the operator's mobile network. A HeNB then scans its environment and, if it detects the radiation of an antenna of the mobile operator using the same frequency as itself nearby, then the HeNB does not activate its antenna since the client is able to benefit from the radio coverage of the mobile infrastructure of the operator. The device is therefore used to provide radio connectivity, from an access network, to a client located in a geographical area lacking any radio coverage from an operator for a given frequency. For an operator, extending the use of Femtocell devices is beneficial in terms of:
making it possible to densify the mobile network for a mobile operator in order to support the growth in usage (increase in data rates and consumed data volumes). The use of Femtocell devices is also relevant for enabling the propagation of millimeter waves, that is to say covering frequencies from 30 to 300 GHz inside buildings.
capitalizing on the deployment of optical fibers and high-speed mobile networks to the client's home by connecting a Femtocell device thereto.

At present, Femtocell devices are sold to mobile network users only if the user, who also has a fixed copper or fiber high-speed subscription, is able to prove that he or she does not have any mobile coverage in his or her fixed connection area, more often than not corresponding to his or her home. This is a temporary solution because the antenna of the Femtocell device is deactivated as soon as the operator subsequently covers this area (it is then said that the operator densifies its mobile network) by deploying an antenna connected to the mobile infrastructure.

A client who purchases a Femtocell device therefore does not use this device once the operator associated with the Femtocell deploys an antenna that densifies its mobile infrastructure and allows the client to have a wireless connection without having to use the Femtocell device. A Femtocell device is also associated with a single operator. Specifically, the Femtocell device transmits over a frequency range corresponding to the range available to the operator of the mobile infrastructure. A Femtocell device furthermore cannot be used in a geographical area other than the one for which it was sold. Specifically, its position is regularly checked and it is deactivated if a location outside the intended area is detected. A Femtocell device cannot be used at the same time as a radio infrastructure of the operator associated with the Femtocell device since the Femtocell device and the radio infrastructure transmit on the same frequency bands, and the activation of the Femtocell device in an area in which a radio signal is able to be detected on an identical frequency band would cause disturbance or interference and a poor quality of service for clients located in the area.

FIG. 1 illustrates the usage context of a Femtocell device. The Femtocell device located in the area 1 is deactivated because an antenna of a mobile network, called macro antenna, is broadcasting in the geographical area (Area 1) where the Femtocell device Femto is located on the same frequency thereas. By contrast, in area 2, which is lacking any radio coverage provided by a macro antenna, the Femtocell device Femto is activated and provides radio coverage for the terminals located in this area.

Femtocell devices are configured, more often than not via a HeNB mgt (Management) management device, for example using the TR069 protocol (https://www.broadband-forum.org/technical/download/TR-196_Issue-2.pdf), so as to be activated only by an operator in a well-defined geographical area, and are therefore not used if the Femtocell device detects transmission of a radio signal on the same frequency band as used by the device. The Femtocell device, as deployed, cannot be used to allow any operator to extend its own radio coverage, and its use is limited to the needs of a single operator, limiting the advantages of such a device for a user, who is able to use it only during a period when the radio coverage of a single operator is not sufficient for the user to access communication services.

The present invention aims to rectify these drawbacks.

### 4. SUMMARY OF THE INVENTION

The invention aims to improve the situation by way of a method for temporarily making available an access resource of a local area network of a client of a first operator to at least one second operator, said local area network being connected to a communication infrastructure of the first operator, said access resource initially being able to allow at least one terminal of the client to access to a communication service, the availability-making method being implemented by a configuration entity of the first operator, able to modify at least one parameter of the access resource, and comprising:
a step of transmitting an offer message, comprising at least one item of service data, offering to make the access resource available, to a management entity of the at least one second operator,
a step of receiving a request message requesting the access resource be made available, created by the management entity of the at least one second operator from the received at least one item of data,
a step of transmitting, to the access resource, a configuration message for configuring at least one parameter of said access resource, triggered following the received request message. According to the prior art, access resources, for example of Femtocell type, deployed in the local area networks of operators' infrastructures are specific to the operators and are not shared between the operators. Local area networks are home networks or business networks. Access gateways, also called boxes, which are access resources, are thus specific to each operator, and another operator cannot provide its own clients with access to boxes managed by another operator.

The method makes it possible to overcome these constraints by allowing a second operator to be able to use services of an access device of an infrastructure of a first operator for its own clients. This method has the advantage, for the first operator, of making a return on its investments in terms of the access devices and, for the second operator, of limiting its own investments in terms of updating its own communication infrastructure, of being able to expand its service offering to its clients more quickly, or even of being able to adapt to a sudden event in a given geographical area by using the devices of other operators offering services in the area. The method furthermore allows clients deploying local area networks, at home or in their company, to be able to obtain remuneration from their operator for making an access device available to another operator. From an energy point of view, it is also advantageous to be able to give preference to using access devices that are underused by clients of a first operator in order to allow clients of other operators to benefit therefrom, and thus avoid these other operators deploying access devices and avoid the resource consumption associated with this deployment. The instruction to configure parameters of an access resource of a first operator thus allows clients of a second operator to be able to have access to communication services via access devices attached to a communication infrastructure of the first operator.

According to one aspect of the invention, the availability-making method furthermore comprises a step of periodically receiving a notification message comprising a set of connectivity criteria relating to the access resource prior to the step of transmitting the offer message.

Making access resources available to a second operator requires the first operator to regularly collect data informing the first operator whether the access resources are actually able to be made available to the second operator. This collection makes it possible to select the resources able to be made available and not to impact access to communication services for the client.

According to another aspect of the invention, the set of connectivity criteria of the availability-making method comprises at least one of the following parameters:
a location parameter of the access resource,
a transmission area identifier, called cell identifier, relating to the location of the access resource,
an identifier of the access resource,
a data rate value for the connection of the local area network to the communications infrastructure of the first operator,
information relating to the client.

The various criteria that are received allow the configuration device to apply availability-making policies and to construct a precise offer so that the second operator is able to decide whether an availability-making request is possible and, if so, to specify the request. According to another aspect of the invention, the availability-making method furthermore comprises a step of transmitting, to a device for interconnecting a communication infrastructure of the first operator and a communication infrastructure of the at least one second operator, a settings message for configuring said device.

The purpose of making the access resource available to a second operator is to provide clients of the second operator with access capabilities for their own services. However, the routing of the data relating to these services should be routed and possibly processed by the second operator. Configuring an interconnection device makes it possible to route the flows of an access resource, for example a Femtocell device, to the infrastructure of the second operator by updating the configuration of an interconnection device between the infrastructures of the two operators.

According to another aspect of the invention, the availability-making method furthermore comprises a step of receiving payment data of the client on the basis of the transmitted configuration message.

The method assumes that the access resources are available and that the client for example does not switch off his or her box or Femtocell device when he or she is not using it, or when he or she is not moving the antenna. However, activating the Femtocell box consumes resources, in particular energy resources, and this consumption may lead the client to turn the Femtocell box off if it is not being used. In order to compensate for this consumption of resources and to encourage as many clients as possible to make their access resources available, the clients are remunerated in return for making their access resources available. The remuneration data may correspond to free access time, to financial data or even to discounts on certain products or services from the first operator.

According to another aspect of the invention, the item of service data of the availability-making method comprises at least one frequency band.

Access resources are able to transmit only on a limited and standardized number of frequency bands. The second operator has authorization to transmit on certain frequency bands. Information on a frequency band allows the second operator to be able to respond effectively, or not, to the offer, in the knowledge that, in the absence of a match between the frequency bands in the offer and the transmission capacities of the second operator, there is no benefit for the latter in transmitting a request.

According to another aspect of the invention, the availability-making method furthermore comprises a step of receiving, from the management equipment of the at least one second operator, an update message for updating the availability-making request following the transmission of the configuration message for configuring the access resource.

The second operator may observe, following the configuration of the access resource by the first operator, that the client does not have a high enough data rate or wishes to access new services from the second operator. The method then comprises an option of updating the making available of an access resource once it is being used by the second operator. According to another aspect of the invention, the request message of the availability-making method comprises information relating to an application.

The first operator identifies services that are able to be activated on the antenna on the basis of the QoS of the access used, the capabilities of the Femtocell device, etc. The second operator may thus decide, on the basis of the services available, to use access resources for a particular service, for example, so that its clients are able to transmit and receive real-time services (video, audio, etc.) and streaming services. Depending on the request received, the first operator configures the access resources made available in order for example to filter certain services.

According to another aspect of the invention, the at least one parameter of the availability-making method relates to an application.

The first operator limits access to the access resource for clients of the second operator only to certain applications, such that the networks of the first operator are not impacted by excessively large data flows and/or by unsecured data, for example. This also allows the first operator to guarantee to the second operator the quality of service necessary for the application.

According to another aspect of the invention, at least one parameter of the availability-making method relates to a network slice allocated to transporting data of the at least one second operator.

Configuring network slices makes it possible to transmit and receive data on physical or virtualized equipment that is appropriately configured so as to guarantee the requirements for the data transported on these slices. Assigning a network slice to the traffic of the second operator on the access resources made available makes it possible to isolate and differentiate between the various flows in the access networks.

According to another aspect of the invention, the availability-making method furthermore comprises a step of sending, to the management equipment of the at least one second operator, data regarding the usage of the access resources by the at least one second operator.

The usage data relating to the second operator, that is to say consumed by the second operator or by terminals of clients of the second operator, may possibly be used by the second operator to update its own network infrastructure. Significant use of access resources belonging to the first operator may specifically lead said second operator to deploy its own resources in a given geographical area close to the access resources of the first operator (that is to say close to the Femtocell).

The various aspects of the availability-making method that have just been described may be implemented independently of one another or in combination with one another.

The invention also relates to a device for temporarily making available an access resource of a local area network of a client of a first operator to at least one second operator, said local area network being connected to a communication infrastructure of the first operator, said access resource initially being able to allow at least one terminal of the client to access a communication service, the device being able to modify at least one parameter of the resource, and comprising:
a transmitter, able to transmit
an offer message, comprising at least one item of service data, offering to make the access resource available, to a management equipment of the at least one second operator,
a configuration message, to the access resource, for configuring at least one parameter of said access resource, triggered following the received request message,
a receiver, able to receive a request message requesting the access resource be made available, created by the management equipment of the at least one second operator from the received at least one item of data.

This device, which is able, in all of its embodiments, to implement the availability-making method that has just been described, is intended to be implemented in a configuration equipment or control equipment of an operator.

The invention also relates to a system for temporarily making available an access resource of a local area network of a client of a first operator to at least one second operator, said local area network being connected to a communication infrastructure of the first operator, said access resource initially being able to allow at least one terminal of the client to access a communication service, comprising:
a configuration entity comprising an availability-making device,
the access resource able to receive, from the configuration entity, a configuration message for configuring at least one parameter.

The invention also relates to a computer program comprising instructions for implementing the steps of the availability-making method that has just been described when this program is executed by a processor.

This program may use any programming language and be in the form of source code, object code or intermediate code between source code and object code, such as in a partially compiled form, or in any other desirable form.

The invention also targets a computer-readable information medium comprising instructions of the computer program as mentioned above.

The information medium may be any entity or device capable of storing the programs. For example, the medium may include a storage means, such as a ROM, for example a CD-ROM or a microelectronic circuit ROM, or else a magnetic recording means, or a hard disk. Moreover, the information medium may be a transmissible medium such as an electrical or optical signal, which may be routed via an electrical or optical cable, by radio or by other means. The program according to the invention may in particular be downloaded from an Internet-type network.

Alternatively, the data medium may be an integrated circuit into which the program is incorporated, the circuit being suitable for executing or for being used in the execution of the method in question.

### 5. BRIEF DESCRIPTION OF THE DRAWINGS

Other advantages and features of the invention will become more clearly apparent from reading the following description of one particular embodiment of the invention, given by way of simple illustrative and non-limiting example, and the appended drawings, in which:

FIG. 2 shows a simplified view of a communication architecture according to the prior art,

FIG. 3 shows a simplified view of a communication architecture in which the availability-making method according to one aspect of the invention is implemented,

FIG. 4 shows an overview of the availability-making method according to a first embodiment,

FIG. 5 shows an overview of the availability-making method according to a second embodiment,

FIG. 6 shows an exemplary structure of an availability-making device according to one aspect of the invention.

### 6. DESCRIPTION OF THE EMBODIMENTS

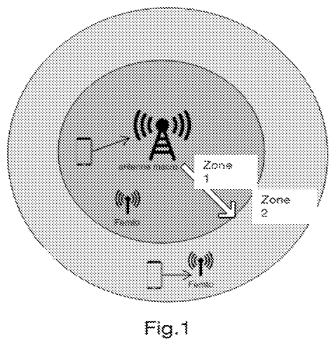

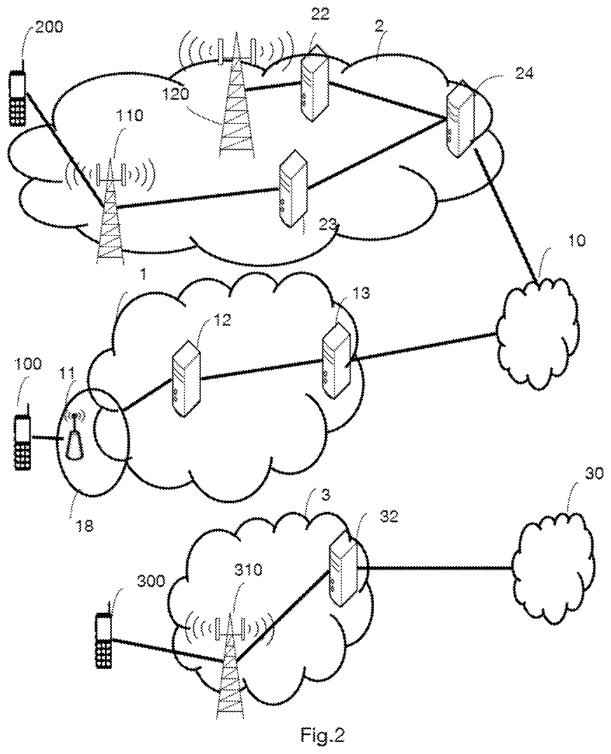

The remainder of the description presents examples of several embodiments of the invention in a communication architecture. The invention may be implemented in architectures based on any 3GPP (GPRS (General Packet Radio Service), UMTS (Universal Mobile Telecommunications System), 4G (Fourth Generation) or 5G (Fifth Generation)) version. Reference is made first of all to [FIG. 2], which shows a simplified view of a communication architecture according to the prior art.

In this [FIG. 2], three access networks 1, 2, 3 are administered by three respective operators A, B, C. The network 1 is said to be fixed, that is to say it offers services based on a fixed architecture, such as an architecture based on xDSL technologies or else fiber technologies. The network 2 is a mobile network. This network 2 offers services to the clients of an operator B on a mobile architecture, for example based on technologies from 3GPP (3rd Generation Partnership Project) or 3GPP2 (3rd Generation Partnership Project). The network 3 is also a mobile network, and this network is operated by an operator C.

The local area network 18 comprises an access point 11 offering wireless access, for example cellular access, to the terminal 100. The local area network 18 is connected to a fixed or mobile connection node 12 of the network 1. The local area network 18 may be a home local area network or a company network, and it may be connected to the node 12 via the access point 11 or by another equipment of the local area network 18. The node 12 may be for example be a BNG (Broadband Network Gateway) equipment or a router equipment. The node 12 is itself connected to a device 13 for interconnection with the network 10. This network 10 is a data transport network for routing said data to application servers, and may for example be a mobile core network.

The network 2 comprises two radio transmitters 110 and 120, to which the terminal 200 is able to attach, and these two transmitters are respectively connected to two routers 22 and 23, which are themselves connected to an interconnection device 24. This interconnection device 24 is itself, in one particular case, connected to the transport network 10. This could also be a transport network separate from the network 10.

The mobile network 3 itself comprises a radio antenna 310 allowing the terminal 300, a client of the operator C, to access multimedia services, specific or not specific to the operator C. The radio antenna 310 is connected to the interconnection device 32 of the network 3. This device 32 interconnects the network 3 with a transport network 30.

According to the prior art, the terminals 100, 200, 300 are respectively able to attach only to the networks 1, via the local area network 18, 2 and 3 since they are respectively clients of the operators A, B and C administering the respective networks 1, 2 and 3. If the operators A and B are identical, it is possible for the two terminals 100 and 200 to be able to attach indiscriminately to the access point 11 and to the radio antennas 110 and 120, but this assumes that the terminals are identified and recognized in the architectures 1 and 2. This may be the case for a convergent operator, having a fixed architecture such as the network 1 and a mobile architecture such as the network 2. If the access point 11 transmits on frequencies identical to the antennas 110 and 120, interference may arise and cause a worsening in quality of service for clients. The access point 11 is more often than not deployed when the client of the terminal 100 is not able to receive the radio signal from the antennas 110 and 120. For example, the access point 11 is deployed in the local area network 18 in the home of the client of the terminal 100 in order to provide said client with radio coverage in the absence of radio coverage provided by the antennas 110 and 120. As soon as the access point 11 is able to receive signals from one of the antennas 110 and 120 or from a new antenna deployed in the network 2, then the access point 11, which is for example a Femtocell access point, is deactivated and it becomes inoperative and redundant for the terminal 100, but also for any terminal. For example, in [FIG. 2], the terminal 300 is possibly out of range of the antenna 310 but within range of the access point 11, but is not able to attach thereto because the client in possession of the terminal 300 is a client of the operator C and is not able to be identified and recognized by the network 1, preventing the terminal 300 from connecting to the network 1 via the network 18.

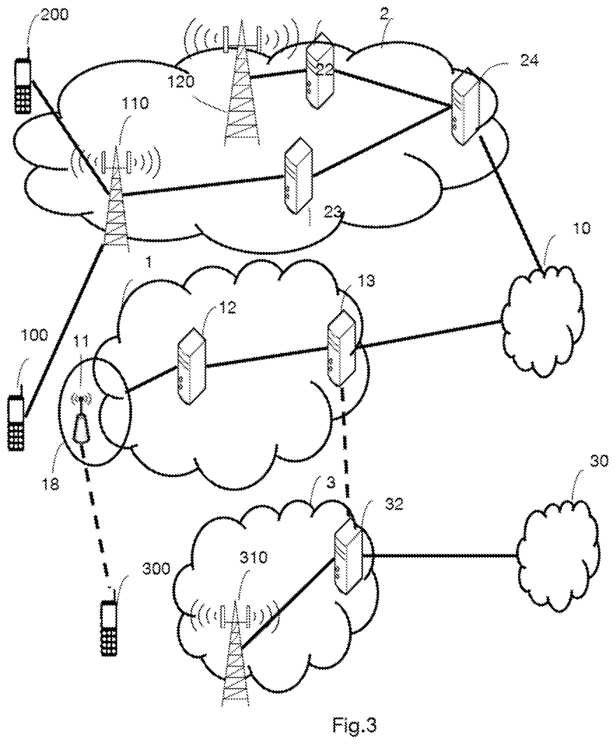

With reference to [FIG. 3], this shows a simplified view of a communication architecture in which the availability-making method according to one aspect of the invention is implemented.

In this [FIG. 3], it is considered that the operator C, administering the network 3, does not have an agreement with the operator A, administering the network 1 to which the local area network 18 is connected. It is furthermore considered that the access point 11 of the local area network 18 of the client in possession of the terminal 100 is able to connect to the antenna 110 that is administered by the operator B, which has an agreement with the operator A or else which is the same as the operator A, thereby obviating the access point 11 for the terminal 100. The terminal 300 of a client of the operator C is out of range of the antenna 310, either because of an excessively great distance between the terminal 300 and the antenna 310, or because the antenna 310 is inoperative. It is therefore impossible for the terminal 300 to access multimedia services using the network 3 of the operator C since it has no connectivity with a network of the operator C.

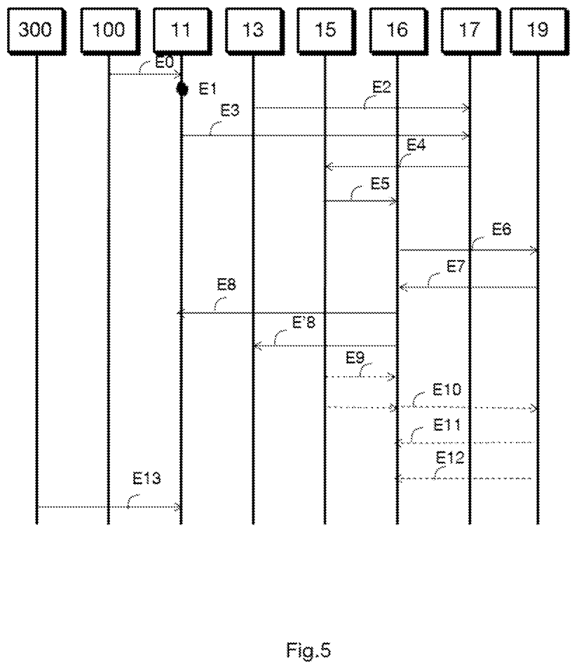

The terminal 300 is however within the coverage of the access point 11 of the local area network 18, the operator C having been informed, by the operator A, of the availability of the access point 11 of the operator A, of its capacity and of its geographical location, as specified in [FIG. 5]. The terminal 300, once the access point 11 has been configured so that terminals of the operator C are able to attach thereto, may then connect to the access point 11. It is also necessary to route the flows from the terminal 300 to a network of the operator C so that the client in possession of the terminal 300 is able to access the services offered by the operator C and have the security, quality of service and billing policies specific to the operator C applied thereto. According to one example, the interconnection device 13 of the network 1 is dynamically connected to the device 32 of the network 3 in order to route the data flows from the terminal 300 to the network 3 and then the network 30.

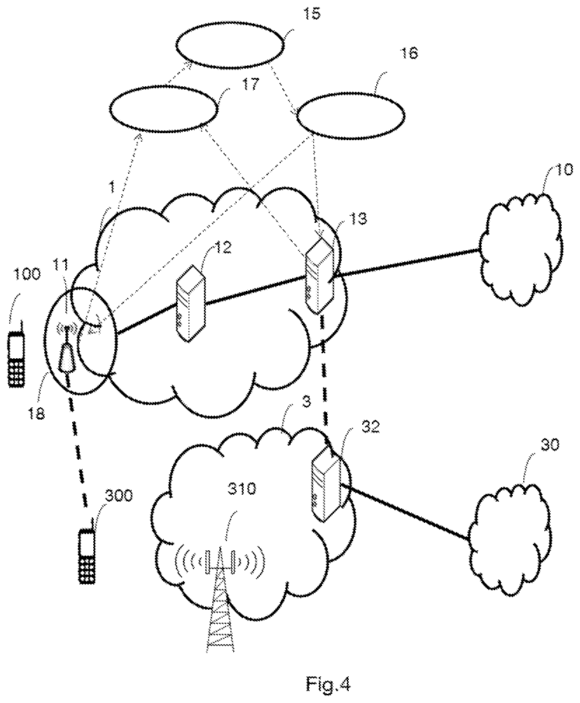

Reference is now made to [FIG. 4], which shows an overview of the availability-making method according to a first embodiment of the invention.

In this [FIG. 4], the networks 1 and 3 are shown only in the knowledge that the purpose of the method is to make available to the operator C, administering the network 3, an access point 11 of a local area network 18 belonging to a client of the network 1, the network 1 being administered by the operator A. As a reminder, the access point 11 of the local area network is initially intended only to provide a connection to the terminals of the client using the local area network 18, this client having a contract with the operator A. The access point 11, according to this embodiment, is a Home eNodeB access resource (called HeNB in the remainder of the text). According to another example, the access resource may also be a home gateway, called a box, or even an access router of a business local area network.

The HeNB transmits service information to the service management entity 15 for a set of HeNBs. The HeNB 11 thus sends messages, possibly periodically, to the data analysis entity 15. The entity 15 furthermore receives service information from the interconnection device 13, which is called HeNBGW in this embodiment. Apart from the role of interconnection with the mobile core network 10, the HeNBGW entity 13 also has the role of aggregating the traffic from the various HeNBs deployed in the network 1 to the network 10. It should moreover be noted that the data analysis entity 15 obtains the information from the HeNB 11 and from the HeNBGW 13 directly or through a resource administration entity 17 (HeNB-Mgt), these resources being the HeNB 11 and the HeNBGW 13. For example, this HeNB-Mgt entity 17 transmits to the entity 15, from among all the information transmitted thereto by the HeNB 11 and the HeNBGW 13, only the information useful for the availability-making method. This HeNB-Mgt entity 17 may also be used to configure the HeNB 11 and the HeNBGW 13, for example using the TR069 protocol (https://www.broadband-forum.org/technical/download/TR-196_Issue-2.pdf). According to another example, the HeNB 11 and the HeNBGW 13 transmit their service information directly to the data analysis entity 15.

The entity 15 analyzes the information on the use of the resources from the HeNB 11, for example by collecting the information from the HeNb-Mgt 17, in addition to the information from the HeNBGW 13 on the users who have connected. This makes it possible to identify the volume of traffic generated by:
the owner of the HeNB 11, by analyzing the connection data of the terminals of the owner of the HeNB 11 on its antenna and the call detail records (CDR) of the mobile core containing the usage information regarding the HeNB 11, based on the registration data (Logs) from the HeNBGW 13,
visitors to the HeNB 11, by analyzing the connection data of visitors to the HeNB 11 via the connection information (different SIM from the owner, etc.) obtained from the HeNBGW 13. This information is particularly useful once the availability-making method has been implemented,
the services and the quality of the HeNB 11, from the types of connectivity of the HeNB 11. This corresponds for example to the concept of network slicing. The HeNB 11 may provide various services that are identified in particular by network slices, and this information on the network slices may influence whether or not the HeNB 11 is made available as well as the services offered to the operator C on the HeNB 11.

The analysis entity 15 may optionally obtain information from the fixed or mobile network 1 in order to ascertain the features of the fixed or mobile access used to route the data of the local area network 18 and of the HeNB 11 (types of fixed access (fiber, xDSL, etc.), types of mobile access (5G, 4G, 3G), speed, quality of service, etc.). According to another example, the entity 15 may collect information from other entities of the fixed network 1 and/or of the mobile network 10, so as to have the most precise possible knowledge regarding the capabilities of the HeNB 11. The entity 15 may thus potentially interconnect with several functional entities (HeNB-Mgt 17, AMF (Core Access and Mobility Management Function), SMF (Session Management Function), etc.) (the AMF and the SMF are not shown in the figure) in order to collect information that will decide on the policy for making or not making the HeNB 11 available. A context identifier of the HeNB 11 relating to a session may be used to link all of the service information relating to this session.

Following its acquisition of information, the entity 15 analyzes said information and transmits, to the configuration entity 16, a notification message comprising a set of connectivity criteria of the HeNB 11. This message is transmitted periodically so as to take into account the variations in the criteria and allow the entity 16 to establish an availability-making offer tailored to the contextual variations.

The criteria transmitted to the entity 16 include in particular a location parameter of the HeNB 11. This parameter may be GPS (Global Positioning System) information, an IP (Internet Protocol) address allocated to the HeNB on the fixed network 1 or any other information allowing the HeNB 11 to be geographically or logically located. A transmission area identifier, such as an identifier of the cell where the HeNB 11 is located, may also be transmitted to the entity 16. This may be for example the PLMN-Id (Public Land Mobile Network identifier) network identifier and/or a Cell-Id cell identifier and/or a LAI (Location Area Identifier) location area identifier/TAI (Tracking Area Identifier). An identifier of the HeNB 11 may also be transmitted. This may in particular be an alphanumeric code, an FQDN (Fully Qualified Domain Name) name or an IMSI (International Mobile Subscriber Identity) number. A data rate value between the local area network 18, in which the HeNB 11 is deployed, and the fixed network 1 may also be transmitted to the entity 16 along with information relating to the client, such as for example a client identifier. This information will have been collected beforehand or extracted from the service information by the analysis entity 15 from the HeNB 11, from the HeNbGw 13, from the entity 17 or from any other entity of the fixed network 1 or of the mobile network 10.

The configuration entity 16 then transmits an offer to make the HeNB 11 available to one or more operators and receives, in return, a request message requesting that the HeNB 11 be made available from or more operators to which an offer has been transmitted. These two steps are not shown in [FIG. 4] but will be explained in [FIG. 5]. When the entity 16 has received one or more request messages from one or more operators, it updates the configuration of the HeNB 11 and of the HeNBGW 13 so that clients of this (or these) operator(s) are able to connect to the HeNB 11 and that the data of these clients are able to be routed on the networks of this (or these) operator(s). Thus, in [FIG. 4], the terminal 300, which is a client of the operator C administering the network 3, is able to connect to the HeNB 11 following the configuration of the HeNB 11, and the traffic of the terminal 300 is routed in the networks 3 and 30 of operator C through the configuration of the HeNBGW 13. This is possible because
the operator C has received an offer to make the HeNB 11 available from the operator A
the operator C has transmitted a request to make the access resource (HeNB 11) available, to the operator A
the operator A has confirmed the availability-making request and has configured the HeNB 11 and possibly also the HeNBGW 13 so that terminals of the clients of the operator C, such as the terminal 300, are effectively able to connect to the HeNB 11 and access their services as if they were connected directly to the network 3.

The operator A thus decides to make available the HeNB 11 that is not being used by the client in possession of this HeNB 11, by disclosing its configuration, through a set of parameters, to the operator C. The operator C may thus use this HeNB 11 for the needs of its clients. The operator A may nevertheless maintain the security of the HeNB 11 by disclosing only a few parameters to the operator A. The configuration of the HeNB 11 by the operator A may consist specifically in delegating the administration of the HeNB 11 to the operator C, but preventing certain parameters of the HeNB 11 from being accessible to the operator C, thus allowing the operator A to keep control over the HeNB 11.

Reference is now made to [FIG. 5], which shows an overview of the availability-making method according to a second embodiment of the invention.

The terminal 100 is a smartphone or any equipment capable of attaching to the access resource 11, a Femtocell device (called Femtocell in the remainder of the text), on a frequency band f1 specific to an operator A. The terminal 100 belongs to a client of the operator A and is connected to the access resource 11 using the frequency band f1 in step E0. In step E1, the Femtocell 11 is deactivated for the terminal 100 since the Femtocell 11 has detected that an antenna, which may be an eNodeB, a NodeB or a radio antenna of a 5G network, of the infrastructure of the operator A is transmitting on the frequency band f1 and the signal received from this antenna allows the terminal 100 to attach thereto. The Femtocell 11 is therefore deactivated for the client of the terminal 100.

In step E2, the interconnection device 13, responsible for interconnecting the network 1 of the operator A with other networks, in particular managed by other operators, transmits service information to the access resource management entity 17. The device 13 may be for example a router or a proxy. The service information that is sent relates for example to the volume of data managed by the device 13 as well as its configuration in terms of security and protection.

In step E3, the Femtocell 11 also transmits service information to the management entity 17. Some examples of service information, also called FAP (Femto Access Point) Services in the terminology of the TR-069 protocol mentioned above, are proposed below:
Capacities (managed frequency and radio technology “FreqBandIndicator” (frequency bands available), managed self-configuration services (SON)).
Control (SON service activation, certificate of association with the device 13).
Cell configuration (PLMN-ID, Cell ID, LAI, TAI, neighbor list, interRAT, IntraRAT, voice, video, etc. Radio parameters not managed by the RAN (Radio Access Network), frequency band, etc.), slices available on the antenna.
REM (Radio Environment Measurement), checking of the network location (information on neighboring cells) based on information on the neighboring cells (Identifier, radio power, frequency, LAC (Location Area Code), RAC (Routing Area Code, etc.).
Access management (CSG-Id (Content Services Gateway Identifier), ACL (Access Control Lists), HeNB-Identifier, Number of CSG users (IMSI, MSISDN) of the group of terminals of the CSG), etc., IP address of HenB-mgt 17, Interconnection device 13)
Transport (transport protocol security (SCTP (@IP Address IP Stream Control Transmission Protocol), IPSEC Security association) and QoS (transport measurement (packet loss rate, volume, etc.) by type of service (SCTP, RTP (Real Time Protocol), Real time, Best effort)))
GPS (location of the Femtocell 11, blocking of the Femtocell 11 if it is not located at coordinates permitted by the operator A)

In step E4, the administration entity 17 transmits, to the analysis entity 15, connectivity parameters that are then aggregated with service information that the entity 16 has received beforehand from the access resources 11 and 13. The entity 15, which is for example an NWDA (Network Data Analytics) device, analyzes the parameters received in order to determine the Femtocell devices that are not useful to the operator A. The entity 15 may furthermore determine that, if critical applications are activated on a Femtocell, an extensive collection of connectivity parameters is performed so as not to offer the Femtocell 11 and impact the provision of these critical applications.

It should furthermore be noted that the entity 15 may also obtain connectivity parameters from other equipment (MME (Mobility Management Entity), SMF (Session Management Function, etc.)) in order to refine its analysis of the access resources. It is possible in particular to obtain information on the network slices, associated with the services, deployed on the access resources. Since the Femtocell is attached to a fixed network, the entity 15 may also obtain information from entities of the fixed network, in particular information relating to the data rate, to the access type and to the Quality of Service parameters. Since the Femtocell may also be attached to a mobile access network, the entity 15 may also obtain information relating to the data rate, to the access type and to the Quality of Service parameters of this mobile network. Information relating to the local area network in which the Femtocell 11 is located may also be collected by the analysis entity 15.

It should be noted that the access resources 11 and 13 may transmit their connectivity parameters directly to the analysis entity 15 and that the sending to the entity 17 is one embodiment.

In step E5, the analysis entity 15 transmits, to the configuration entity 16, a notification message comprising a set of connectivity criteria relating to the Femtocell device 11. The entity 16 is for example an NEF (Network Exposure function) device. According to one example, during the analysis of the connectivity parameters received in particular in step E4, the device 15 may consider that the Femtocell 11 is not being used by the client and may be offered to the configuration entity 16. The connectivity criteria comprise relevant information for the operators receiving a possible availability-making offer, such as location parameters of the Femtocell device 11, a transmission area identifier, an identifier of the Femtocell 11 device, a data rate value for the Femtocell device 11, a date and a validity period of the Femtocell device 11 as well as information relating to the client of the terminal 100. It should be noted that step E5, like steps E2, E3 and E4, may be reproduced periodically, depending in particular on variations in the parameters and therefore the connectivity criteria.

In step E6, the configuration entity 16 transmits, to a management entity 19 of a second operator C, an offer message offering to make the Femtocell device 11 available. This message, which may be transmitted to several operators, comprises service data. These service data are for example frequency bands f2, f3, f4 that may be used by the operator C as well as some of the criteria obtained from the analysis entity 15 in step E5.

In step E7, the configuration entity 16 receives a request message requesting the Femtocell device 11 be made available from the management entity 19 of the second operator C. If the offer message transmitted in step E6 comprised frequency bands f2, f3, f4, then the operator C, in particular if it has obtained one of these frequency bands from a regulatory authority, may transmit the request comprising the band in question. It should be noted that the frequency band may correspond to a frequency. According to one alternative, the transmitted request message may furthermore comprise information relating to an application, indicating for example that the operator C wishes to use the Femtocell device so that its clients are able to use one or more applications indicated in the request message. The information may for example indicate TV, Real time, Streaming, VoIP depending on the application or the type of application to be made available to its clients by the operator C.

In step E8, the configuration entity 16 transmits a configuration message for configuring at least one parameter of the Femtocell device 11, triggered following the request message received in step E7 potentially via the management entity 17 that manages the Femtocells. This configuration message aims to modify parameters of the Femtocell 11 device so that the terminal 300, of a client of the operator C, is able to connect thereto and thus access services as if it were attached directly, that is to say without an intermediate network such as the local area network 18 and the network 1 in [FIG. 4], to a network managed by the operator C. According to one alternative, the parameter may be a frequency band. In particular, if the operator C uses the frequency band f2 in the mobile network, for example in the network 3 in [FIG. 4], the Femtocell device 11 is configured so as to transmit data using this frequency band f2 and no longer the frequency band f1 configured beforehand by the operator A for the client in possession of the terminal 100. According to another example, the parameter may correspond to one or more applications. The configuration may consist in prohibiting or authorizing certain application ports on the basis in particular of the received request message. According to another example, the parameter may be information relating to a network slice, allocated to transporting data of the operator C. If the operator A wishes to route the traffic of the clients of various operators, and in particular the operator C, on specific network slices, it is then necessary to configure for example the network slice corresponding to the frequency band and/or applications authorized for the operator C.

It should be noted that these various examples may be implemented together and it is possible to configure multiple parameters.

According to one alternative, the administration of the Femtocell 11 is delegated to the operator C for the period during which this device is made available thereto. This delegation however assumes that some parameters of the Femtocell 11 are not under the control of the operator C, meaning that the operator A retains certain prerogatives on the Femtocell 11. The table in Appendix 1 at the end of the description gives one example of parameters under the control of the operator A and of parameters accessible to the operator C while the Femtocell device 11 is made available to the operator C.

According to one alternative, in step E′8, the configuration entity 16 transmits a settings message for configuring the device 13 for interconnection between the network of the operator A and the network of the operator C so that the data flows from the terminal 300 are routed to the network of the operator C, thus allowing the terminal 300 to access the services of the operator C and allowing the operator C to process the data transmitted and received by the terminal 300 potentially via the management entity 17 that manages the Femtocell gateways.

According to one example, the analysis entity 15, receiving data from the Femtocell 11 and from the interconnection device 13, possibly via the administration entity 17, transmits, in step E9, to the configuration entity 16, data relating to the terminal 300 that are intended to be used to remunerate the client of the terminal 100 who has made his or her Femtocell device 11 available to the operator C via the operator A.

According to another example, the configuration entity 16, in step E10, transmits, to the management entity 19 of the operator C, data regarding the use of the Femtocell device by the terminal 300. These data allow the operator C to monitor the use of the Femtocell device 11 by its clients, and also to check possible billing for the availability-making method by the operator A to the operator C. According to one alternative, the management entity 19 of the operator C transmits, in step E11, to the configuration entity 16, an acknowledgement message acknowledging that the Femtocell device 11 has been made available, indicating that the Operator C has checked that the making available complies with the availability-making request and that the operator A is able to issue billing tickets for making it available.

The operator C may furthermore decide to modify the availability-making request, in step E12, for example so that the terminal 300 has higher data rates or accesses more applications. In this case, the management entity 19 of the operator C transmits an update message to update the availability-making request message, once the configuration of the Femtocell device 11 has taken place. This update message comprises an updated parameter or else a new parameter that was not contained in the previous availability-making request.

In step E13, which may, according to one alternative, take place just after step E8, the terminal 300 belonging to a client of an operator C may attach to the Femtocell device 11 of a client of the operator A, this device being made available to the operator C.

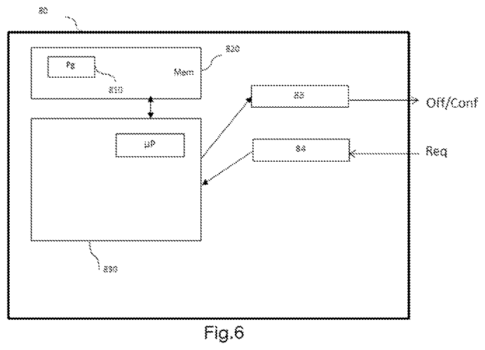

With reference to [FIG. 6], this shows an exemplary structure of an availability-making device according to one aspect of the invention.

The availability-making device 80 implements the availability-making method, various embodiments of which have just been described.

Such a device 80 may be implemented in a configuration device. The configuration device may be an equipment on a fixed network or on a mobile network. The configuration device may in particular be an NEF device for a fifth-generation 3GPP network.

For example, the device 80 comprises a processing unit 830, equipped for example with a microprocessor μP, and driven by a computer program 810, stored in a memory 820 and implementing the availability-making method according to the invention. On initialization, the code instructions of the computer program 810 are for example loaded into a RAM memory, before being executed by the processor of the processing unit 830.

Such a device 80 comprises:
a transmitter 83, able to transmit
an offer message Off, comprising at least one item of service data, offering to make the access resource available, to at least one second operator,
a configuration message Conf for configuring at least one parameter of the access resource, triggered following the received request message,
a receiver 84, able to receive a request message Req requesting the access resource be made available, created by the at least one second operator from the received at least one item of data.

The availability-making method allows an operator to be able to delay deployment of a communications infrastructure or even to dispense therewith by using the resources of another operator. Client access devices are more often than not associated with a given operator and are generally not shared or loaned to clients of another operator. The availability-making method, which aims to assign an access device of a client of a first operator to the routing of data of a client of a second operator, allows the first operator to enrich the provision of services by the access devices that it manages, and makes it possible for the second operator not to have to invest in new architectures but to still guarantee its clients access to a more geographically and temporally extensive access offering. The availability-making method is based on a collaborative process between operators that allows their respective clients to benefit from this collaboration, the former by benefiting from a better access offering and the latter by being compensated for making their resources available.

APPENDIX 1

| | | Parameters able to be |
|---|---|---|
| Examples of | | configured only by the |
| parameters | Parameters able to be configured only by the operator A | operator C |
| Configuration of | Operation examples: | No access to the configuration |
| the connectivity | “.FAPService.{i}.FAPControl.UMTS.Gateway.”, | of these parameters |
| between the | “.FAPService.{i}.Transport.” with the following sub- | |
| Femtocell device | operations: “SCTP”, “TUNNEL”, “SECURITY” | |
| 11 and the | Example for configuring the termination node of the tunnel: | |
| interconnection | “.FAPService.{i}.Transport.Tunnel.IKESA.{i}.PeerAddress” | |
| device 13 | | |
| Management of | Operation example: | The service for activating a |
| the QoS for | “InternetGatewayDevice.QueueManagement.Flow.{i}.” for | QoS policy for a given type of |
| conversational, | the flowing flows | flow depends on the transport |
| video, interactive | “urn:broadband-forum-org:gtp-conversational”, | capacities. For example, |
| or best effort flows | “urn:broadband-forum-org:gtp-streaming”, “urn:broadband- | depending on the quality of the |
| managed by the | forum-org:gtp-interactive”, | link, the operator A offers or |
| Femtocell device | “urn:broadband-forum-org:gtp-besteffort” | does not offer the “interactive” |
| 11 | Example for allowing conversational flows: | type. |
| | “InternetGatewayDevice.QueueManagement.Flow. | |
| | urn:broadband-forum-org:gtp-conversational.flow = “enable” | |
| Possibility of | Operations for retrieving the geographical location of the | The location-changing service |
| changing the | antenna: “FAPService.{i}.GPS” with the following as | cannot be configured by the |
| location of the | possible attributes: | operator C. |
| antenna | “LockedLatitude, | By contrast, a service for |
| | LockedLongitude, | reading the radio location or |
| | ScanOnBoot or | geographical location of the |
| | ScanPeriodically” | antenna is possible |
| Give a name to a | Operations for associating the antenna with an operator | These operations may be |
| cell associated | (PLMN) In the core network: | managed by the operator C |
| with a technology, | “.FAPService.{i}.CellConfig.UMTS.CN” with the following as | |
| i.e. UMTS + | parameters: PLMNType, PLMNID | |
| configuration of | In the access network: | |
| the frequencies | “.FAPService.{i}.CellConfig.UMTS.RAN” with the following as | |
| | parameters: CellID (identifier of the UMTS cell), | |
| | TRatC/URAList/RNCID | |
| Manage the | Operations for configuring the performance metrics (antenna, | in read mode only: no option to |
| performance of the | transport (from the antenna to the secure GW)) to be fed | modify the types of feedback or |
| cell | back | the sending frequencies of |
| | | these management reports |

Although the present disclosure has been described with reference to one or more examples, workers skilled in the art will recognize that changes may be made in form and detail without departing from the scope of the disclosure and/or the appended claims.

1. An availability-making method for temporarily making available an access resource of a local area network of a client of a first operator to at least one second operator, said local area network being connected to a communication infrastructure of the first operator, said access resource initially being able to allow at least one terminal of the client to access to a communication service, the availability-making method being implemented by a configuration entity of the first operator, able to modify at least one parameter of the access resource, and comprising:
transmitting an offer message, comprising at least one item of service data, offering to make the access resource available, to a management entity of the at least one second operator,
receiving a request message requesting the access resource be made available, created by the management entity of the at least one second operator from the received at least one item of data, and
transmitting, to the access resource, a configuration message for configuring at least one parameter of said access resource, triggered following the received request message.

2. The availability-making method as claimed in claim 1, furthermore comprising periodically receiving a notification message comprising a set of connectivity criteria relating to the access resource prior to transmitting the offer message.

3. The availability-making method as claimed in claim 2, wherein the set of connectivity criteria comprises at least one of the following parameters:
a location parameter of the access resource,
a transmission area identifier, called cell identifier, relating to the location of the access resource,
an identifier of the access resource,
a data rate value for the connection of the local area network to the communications infrastructure of the first operator,
information relating to the client.

4. The availability-making method as claimed in claim 1, furthermore comprising transmitting, to a device for interconnecting a communication infrastructure of the first operator and a communication infrastructure of the at least one second operator, a settings message for configuring said device.

5. The availability-making method as claimed in claim 1, furthermore comprising receiving payment data of the client on the basis of the transmitted configuration message.

6. The availability-making method as claimed in claim 1, wherein the item of service data comprises at least one frequency band.

7. The availability-making method as claimed in claim 1, furthermore comprising receiving, from the management equipment of the at least one second operator, an update message for updating the availability-making request following the transmission of the configuration message for configuring the access resource.

8. The availability-making method as claimed in claim 1, wherein the request message comprises information relating to an application.

9. The availability-making method as claimed in claim 1, wherein the at least one parameter relates to an application.

10. The availability-making method as claimed in claim 1, wherein the at least one parameter relates to a network slice allocated to transporting data of the at least one second operator.

11. The availability-making method as claimed in claim 1, furthermore comprising sending, to the management equipment of the at least one second operator, data regarding the usage of the access resources by the at least one second operator.

12. A device for temporarily making available an access resource of a local area network of a client of a first operator to at least one second operator, said local area network being connected to a communication infrastructure of the first operator, said access resource initially being able to allow at least one terminal of the client to access a communication service, the device being able to modify at least one parameter of the resource, and comprising:
a transmitter, configured to transmit:
an offer message, comprising at least one item of service data, offering to make the access resource available, to a management equipment of the at least one second operator, and
a configuration message, to the access resource, for configuring at least one parameter of said access resource, triggered following the received request message, and
a receiver, configured to receive a request message requesting the access resource be made available, created by the management equipment of the at least one second operator from the received at least one item of data.

13. A system for temporarily making available an access resource of a local area network of a client of a first operator to at least one second operator, said local area network being connected to a communication infrastructure of the first operator, said access resource initially being able to allow at least one terminal of the client to access a communication service, the system comprising:
a configuration entity to modify at least one parameter of the resource, and comprising:
a transmitter, configured to transmit:
an offer message, comprising at least one item of service data, offering to make the access resource available, to a management equipment of the at least one second operator, and
a configuration message, to the access resource, for configuring at least one parameter of said access resource, triggered following the received request message, and
a receiver, configured to receive a request message requesting the access resource be made available, created by the management equipment of the at least one second operator from the received at least one item of data, and
the access resource, which is configured to receive, from the configuration entity, the configuration message for configuring at least one parameter.

14. (canceled)

15. A non-transitory computer-readable recording medium comprising a computer program stored thereon comprising instructions which, when executed by a processor of a configuration entity of a first operator, configure the configuration entity to implement a method temporarily making available an access resource of a local area network of a client of the first operator to at least one second operator, said local area network being connected to a communication infrastructure of the first operator, said access resource initially being able to allow at least one terminal of the client to access to a communication service, wherein the instructions configure the configuration entity to:
transmit an offer message, comprising at least one item of service data, offering to make the access resource available, to a management entity of the at least one second operator,
receive a request message requesting the access resource be made available, created by the management entity of the at least one second operator from the received at least one item of data, and
transmit, to the access resource, a configuration message for configuring at least one parameter of said access resource, triggered following the received request message.

16. An access resource of a local area network of a client of a first operator temporarily made available to at least one second operator, said local area network being connected to a communication infrastructure of the first operator, said access resource initially being configured to allow at least one terminal of the client to access a communication service, said access resource being configured to receive, from the configuration entity, a configuration message for configuring at least one parameter allowing a terminal of a client of the second operator to connect to said access resource.
